(19) United States
(12) Patent Application Publication
(10) Pub. No.: US 2023/0409869 A1
(43) Pub. Date: Dec. 21, 2023

(54) PROCESS FOR TRANSFORMING A TRAINED ARTIFICIAL NEURON NETWORK

(71) Applicant: STMicroelectronics ( Rousset ) SAS, Rousset (FR)

(72) Inventors: Laurent Folliot, Gourdon (FR); Pierre Demaj, Nice (FR)

(21) Appl. No.: 18/316,152

(22) Filed: May 11, 2023

(30) Foreign Application Priority Data
Jun. 15, 2022 (FR) 2205831

(51) Int. Cl. G06N 3/04

(52) U.S. Cl. CPC G06N 3/04

(57) ABSTRACT

According to one aspect, there is proposed a method for transforming a trained artificial neural network including a binary convolution layer followed by a pooling layer then a batch normalization layer, the method includes obtaining the trained artificial neural network and transforming the trained artificial neural network such that the order of the layers of the trained artificial neural network is modified by displacing the batch normalization layer after the convolution layer.

### CROSS-REFERENCE TO RELATED APPLICATIONS

This application claims the priority to French Application No. 2205831, filed on Jun. 15, 2022, which application is hereby incorporated by reference herein in its entirety.

### TECHNICAL FIELD

Embodiments and implementations relate to artificial neural networks.

### BACKGROUND

Artificial neural networks generally comprise a succession of layers of neurons. Each layer takes input data to which weights are applied and outputs output data after processing by functions for activating the neurons of said layer. This output data is passed to the next layer in the neural network.

The weights are data (i.e., parameters) of configurable neurons to obtain good data at the output of the layers. The weights are adjusted during a generally supervised learning phase, in particular by executing the neural network with, as input data, already classified data from a reference database.

The neural networks can be quantized to accelerate their execution and reduce memory requirements. In particular, the quantization of the neural network consists of defining a format for representing neural network data, such as the weights and inputs and outputs of each neural network layer. The layers of a neural network can be quantized in floating point, in eight bits, or binary, for example.

A trained neural network can thus include at least one layer quantized in binary. The weights of said at least one layer then take the value ‘0,’ or ‘1’. The values generated by the neural network layers can also be binary, taking the value ‘0,’ or ‘1’. The neural network can nevertheless have certain layers, in particular an input layer and an output layer, quantized in eight bits or floating points. The layers (e.g., hidden layers) located between the input and output layers can then be binary quantized. A binary quantized neural network for most layers can be obtained to identify (classify) an element in a physical signal.

When it is desired to develop a neural network that is at least partially binary quantized, the succession of layers is ordered to optimize the training of the neural network. In particular, it is common to use a series of layers, including a convolution layer followed by a pooling layer and then a batch normalization layer.

The quantized neural networks, once trained, are integrated into integrated circuits, such as microcontrollers. In particular, it is possible to use integration software to integrate a quantized neural network into an integrated circuit. The integration software can be configured to convert the quantized neural network into a transformed neural network (e.g., optimized) to be executed on a given integrated circuit.

For example, the integration software STM32Cube.AI and the extension X-CUBE-AI thereof, which are developed by the company STMicroelectronics, are known. The execution of the neural network can require significant memory resources to store the weights and the data generated by the neural network (e.g., the activations). The execution of the neural network can also be performed over a high number of processing cycles.

There is, therefore, a need to propose solutions allowing reducing the memory use and the number of cycles required for the execution of an artificial neural network while maintaining good accuracy of the neural network.

### SUMMARY

According to one aspect, there is provided a method for transforming a trained artificial neural network, including a binary convolution layer followed by a pooling layer and then a batch normalization layer; the method includes obtaining the trained artificial neural network, then transforming the trained artificial neural network wherein the order of the layers of the trained artificial neural network is modified by displacing the batch normalization layer after the convolution layer.

Such a method allows inverting the pooling layer and the batch normalization layer. The displacement of the batch normalization layer does not change the accuracy of the neural network because placing the batch normalization layer after the convolution layer is mathematically equivalent to having the batch normalization layer after the pooling layer. Indeed, the batch normalization layer performs a linear transformation.

Nevertheless, the displacement of the normalization layer allows for reducing the execution time of the neural network by decreasing the number of processor cycles to execute the neural network. The displacement of the normalization layer also reduces the memory occupation for the execution of the neural network. Thus, the implementation of such a transformation method can allow an optimization of the trained artificial neural network by converting it into a transformed artificial neural network, in particular, optimized. The batch normalization layer is merged with the convolution layer in an advantageous embodiment.

Preferably, the pooling layer is converted into a binary pooling layer. Obtaining a binary pooling layer is allowed thanks to the displacement of the batch normalization layer before the pooling layer. Using a binary pooling layer simplifies the execution of the transformed neural network. Thus, the transformed neural network can be executed more quickly.

Advantageously, the pooling layer of the trained artificial neural network is a maximum pooling layer, and this pooling layer is converted into a binary maximum pooling layer. A binary maximum pooling layer can be implemented by a simple “AND” type logic operation and can therefore be executed quickly.

Alternatively, the pooling layer of the trained artificial neural network is a minimum pooling layer, and this pooling layer is converted into a binary minimum pooling layer. A binary minimum pooling layer can be implemented by a simple “OR” type logic operation and executed quickly.

In an advantageous implementation, the batch normalization layer of the trained artificial neural network and the transformed artificial neural network is configured to perform a binary conversion and a bit-packing.

According to another aspect, a computer program product is proposed comprising instructions which, when a computer executes the program, lead it to implement an artificial neural network including a binary convolution layer followed by a batch normalization layer, then a pooling layer.

In embodiments, a computer program product is proposed comprising instructions which, when a computer executes the program, lead it to implement a transformed artificial neural network obtained by implementing a method as previously described.

The convolution and batch normalization layers are merged in an embodiment.

In embodiments, the pooling layer is a binary pooling layer. In embodiments, the pooling layer is a binary maximum pooling layer. In embodiments, the pooling layer is a binary minimum pooling layer. In embodiments, the batch normalization layer is configured to perform a binary conversion and a bit-packing.

In embodiments, a microcontroller is proposed comprising a memory wherein a computer program product is stored as previously described and a calculation unit configured to execute this computer program product.

In embodiments, a computer program product is proposed with instructions which, when a computer executes the program, lead it to implement a method described above.

### BRIEF DESCRIPTION OF THE DRAWINGS

Other advantages and features of the invention will appear on examining the detailed description of embodiments, without limitation, and of the appended drawings wherein:

FIG. 1 is a flow chart of an embodiment method for transforming a trained artificial neural network;

FIG. 2 is a diagram of an embodiment for transforming a trained artificial neural network; and

FIG. 3 is a block diagram of an embodiment microcontroller.

### DETAILED DESCRIPTION OF ILLUSTRATIVE EMBODIMENTS

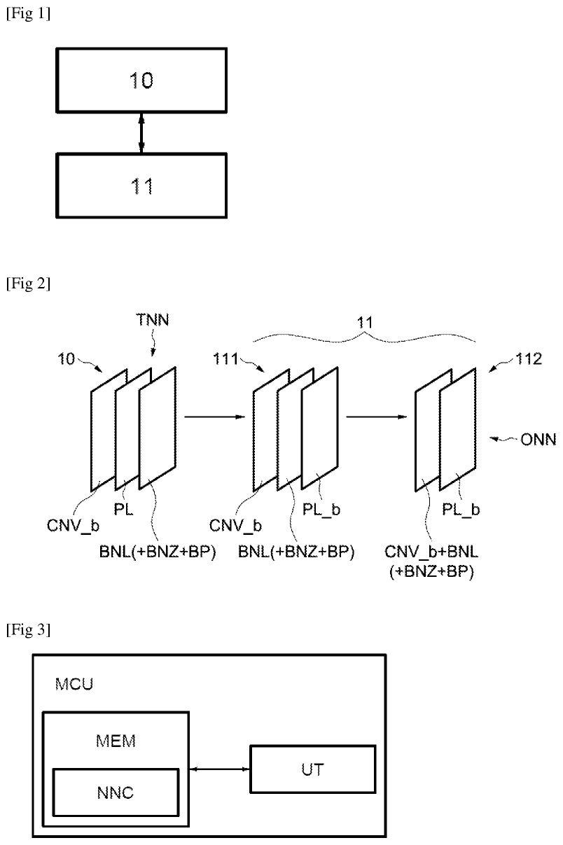

FIGS. 1 and 2 illustrate methods for transforming a trained artificial neural network TNN according to one embodiment of the invention.

The method includes obtaining 10, as input to an integration software, the trained artificial neural network TNN. The training defines a neural network with optimal performance for the nominal resolution and the least degraded possible for the reduced resolution. More specifically, during the neural network training, the neural network weights are adjusted. The performance of the modified network is evaluated according to the different used resolutions. If the neural network's performance is satisfactory, the network's training is stopped. Then, the trained neural network is provided as input to an integration software.

The trained neural network TNN has a succession of layers. This succession of layers conventionally includes a convolution layer CNV_b, a pooling layer PL, and then a batch normalization layer BNL. For example, the convolution layer CNV_b can be a 2D convolution layer. The convolution layer CNV_b is a binary layer. The pooling layer PL can be a maximum (“maxpool”) or minimum (“minpool”) pooling layer. In particular, the pooling layer allows combining the outputs of the convolution layer. The combination of the outputs can consist for example of taking the maximum (“maxPooling”) or minimum (minpooling) value of the outputs of the convolution layer. The pooling layer allows reducing the size of the output maps of the convolution layer, while improving the neural network's performance. The trained neural network may comprise binarization and bit-packing, carried out simultaneously with the batch normalization layer BNL.

Although optimal for training the neural network, such an order of the layers is less efficient for its execution. Indeed, it is advantageous to have, for training, a convolution layer CNV_b followed by the pooling layer PL before the batch normalization layer BNL. In particular, the batch normalization layer BNL allows obtaining data centered around zero with a dynamic adapted to have a correct binary conversion at the input of the binarization layer. Placing the batch normalization layer BNL after the convolution layer CNV_b poses a problem for training because the batch normalization layer BNL would be performed on all data generated at the output of the convolution layer CNV_b, such that the data output from the batch normalization layer BNL would be less well centered reduced. This then poses accuracy problems, as some data output from the batch normalization layer would be overweighted, and other data would be lost.

However, the order of the layers for training is less efficient for the execution of the neural network because it requires a large memory occupation to store the output data of the layers and a large number of processing cycles.

The method includes a conversion 11 performed by the integration software to optimize the trained neural network. Conversion 11 allows converting the trained neural network TNN into a transformed neural network ONN (i.e., optimized). The conversion includes a reorganization in of the layers. The reorganization in of the layers corresponds to a modification of the order of the layers of the neural network.

In embodiments, the batch normalization layer BNL is displaced to succeed in the convolution layer CNV_b. In this manner, the batch normalization layer BNL can be merged 112 with the convolution layer CNV_b. Similarly, the binary conversion BNZ and the bit-packing BP are performed simultaneously with the batch normalization layer BNL.

The displacement of the batch normalization layer BNL does not impact the accuracy of the neural network. On the contrary, this displacement improves the performance of the execution of the neural network in terms of speed and memory occupation. The batch normalization layer BNL then corresponds to a comparison of the output data of the convolution layer CNV_b with a threshold defined during the training of the neural network. The execution of such a batch normalization layer BNL is performed directly on the output data of the convolution layer CNV_b, without new memory accesses.

The displacement 111 of the batch normalization layer BNL allows modifying the pooling layer PL by a binary pooling layer PL_b. The binary pooling layer PL_b may be a binary maximum pooling layer or a binary minimum pooling layer.

In embodiments, a simple “AND” type logic operation implements a binary maximum pooling layer. In another embodiment, a simple “OR” type logic operation can implement a binary minimum pooling layer.

In embodiments, the output of the binary maximum pooling layer can be calculated by the following logic expression: MaxPool=[(A\hat{ }Mask) & (B\hat{ }Mask)]\hat{ }A Mask, where the symbol ‘\hat{ }’ corresponds to an ‘EXCLUSIVE OR’ (‘XOR’) type logic operation, the symbol ‘&’ corresponds to an ‘AND’ type logic operation, ‘Mask’ corresponds to a mask taking the value ‘0’ when a scaling parameter of the batch normalization is positive and the value ‘1’ when the scaling parameter of the batch normalization is negative.

The following logic expression can calculate the output of the binary minimum pooling layer: MinPool=[(A\hat{ }Mask)|(B\hat{ }Mask)]\hat{ }A Mask, where the symbol ‘\hat{ }’ corresponds to an ‘EXCLUSIVE OR’ (‘XOR’) type logic operation, the symbol ‘|’ corresponds to an ‘OR’ type logic operation, ‘Mask’ corresponds a mask taking the value ‘0’ when the scaling parameter of the batch normalization is positive and ‘1’ when the scaling parameter of the batch normalization is negative.

In the case of pool padding of the pooling layer PL_b, the mask is used to initialize the padding values. The output of the pooling layer PL_b has the advantage of being obtained by a simple calculation loop.

Such a method allows obtaining a transformed neural network ONN. In particular, the displacement of the batch normalization layer BNL does not change the accuracy of the neural network because placing the batch normalization layer BNL after the convolution layer CNV_b is mathematically equivalent to having the batch normalization layer after the pooling layer. Indeed, the batch normalization layer BNL performs a linear transformation. On the contrary, the displacement of the normalization layer allows for reducing the execution time of the neural network by decreasing the number of processor cycles to execute the neural network. The displacement of the batch normalization layer also reduces the memory occupation for executing the neural network.

The transformed neural network is integrated into a computer program NNC. This computer program then comprises instructions that lead it to implement the transformed neural network when a computer executes the program.

In particular, the transformed neural network can be embedded in a microcontroller. As illustrated in FIG. 3, such a microcontroller has a memory MEM configured to store the program NNC of the transformed neural network and a processing unit UT configured to execute the transformed neural network.

Another computer program can implement the previously described method concerning FIGS. 1 and 2, this computer program being integrated into the integration software. In this case, the computer program then comprises instructions that lead it to implement the previously described method when a computer executes the program.

What is claimed is:

1. A method, comprising:
having a trained artificial neural network comprising a binary convolution layer, a pooling layer, and a batch normalization layer, wherein the pooling layer is arranged between the binary convolution layer and the batch normalization layer in the trained artificial neural network; and
converting the trained artificial neural network to a transformed artificial neural network, wherein the batch normalization layer is arranged between the binary convolution layer and the pooling layer in the transformed artificial neural network.

2. The method of claim 1, further comprising merging the batch normalization layer with the binary convolution layer in the transformed artificial neural network.

3. The method of claim 1, further comprising converting the pooling layer into a binary pooling layer.

4. The method of claim 3, wherein the pooling layer of the trained artificial neural network is a maximum pooling layer, the method further comprising converting the pooling layer of the trained artificial neural network into a binary maximum pooling layer in the transformed artificial neural network.

5. The method of claim 3, wherein the pooling layer of the trained artificial neural network is a minimum pooling layer, the method further comprising converting the pooling layer of the trained artificial neural network into a binary minimum pooling layer in the transformed artificial neural network.

6. The method of claim 1, further comprising performing a binary conversion and a bit-packing by the batch normalization layer.

7. The method of claim 1, wherein the trained artificial neural network is used during a training of a corresponding artificial neural network, and wherein the transformed artificial neural network is used during an execution of data based on the training.

8. A non-transitory computer-readable media storing computer instructions that, when executed by a processor, cause the processor to convert a trained artificial neural network to a transformed artificial neural network, wherein the trained artificial neural network comprises a binary convolution layer, a pooling layer, and a batch normalization layer, wherein the pooling layer is arranged between the binary convolution layer and the batch normalization layer in the trained artificial neural network, and wherein the batch normalization layer is arranged between the binary convolution layer and the pooling layer in the transformed artificial neural network.

9. The non-transitory computer-readable media of claim 8, wherein the computer instructions, when executed by the processor, cause the processor to merge the batch normalization layer with the binary convolution layer in the transformed artificial neural network.

10. The non-transitory computer-readable media of claim 8, wherein the computer instructions, when executed by the processor, cause the processor to convert the pooling layer into a binary pooling layer.

11. The non-transitory computer-readable media of claim 8, wherein the pooling layer of the trained artificial neural network is a maximum pooling layer, and wherein the computer instructions, when executed by the processor, cause the processor to convert the pooling layer of the trained artificial neural network into a binary maximum pooling layer in the transformed artificial neural network.

12. The non-transitory computer-readable media of claim 8, wherein the pooling layer of the trained artificial neural network is a minimum pooling layer, and wherein the computer instructions, when executed by the processor, cause the processor to convert the pooling layer of the trained artificial neural network into a binary minimum pooling layer in the transformed artificial neural network.

13. The non-transitory computer-readable media of claim 8, wherein the computer instructions, when executed by the processor, cause the processor to perform a binary conversion and a bit-packing by the batch normalization layer.

14. The non-transitory computer-readable media of claim 8, wherein the trained artificial neural network is used during a training of a corresponding artificial neural network, and wherein the transformed artificial neural network is used during an execution of data based on the training.

15. A microcontroller, comprising:
a non-transitory memory storage comprising instructions; and
a processor in communication with the non-transitory memory storage, wherein the instructions, when executed by the processor, cause the processor to convert a trained artificial neural network stored embedded in the microcontroller to a transformed artificial neural network, wherein the trained artificial neural network comprises a binary convolution layer, a pooling layer, and a batch normalization layer, wherein the pooling layer is arranged between the binary convolution layer and the batch normalization layer in the trained artificial neural network, and wherein the batch normalization layer is arranged between the binary convolution layer and the pooling layer in the transformed artificial neural network.

16. The microcontroller of claim 15, wherein the instructions, when executed by the processor, cause the processor to merge the batch normalization layer with the binary convolution layer in the transformed artificial neural network.

17. The microcontroller of claim 15, wherein the instructions, when executed by the processor, cause the processor to convert the pooling layer into a binary pooling layer.

18. The microcontroller of claim 15, wherein the pooling layer of the trained artificial neural network is a maximum pooling layer, and wherein the instructions, when executed by the processor, cause the processor to convert the pooling layer of the trained artificial neural network into a binary maximum pooling layer in the transformed artificial neural network.

19. The microcontroller of claim 15, wherein the pooling layer of the trained artificial neural network is a minimum pooling layer, and wherein the instructions, when executed by the processor, cause the processor to convert the pooling layer of the trained artificial neural network into a binary minimum pooling layer in the transformed artificial neural network.

20. The microcontroller of claim 15, wherein the instructions, when executed by the processor, cause the processor to perform a binary conversion and a bit-packing by the batch normalization layer.
